(19) United States
(12) Patent Application Publication
(10) Pub. No.: US 2025/0265940 A1
(43) Pub. Date: Aug. 21, 2025

(54) INFORMATION PROCESSING SYSTEM, INFORMATION PROCESSING METHOD, AND COMPUTER-READABLE STORAGE MEDIUM

(71) Applicant: CANON KABUSHIKI KAISHA, Tokyo (JP)

(72) Inventors: TAKUTO WATANABE, Kanagawa (JP); TAKANOBU SUZUKI, Kanagawa (JP)

(21) Appl. No.: 19/046,720

(22) Filed: Feb. 6, 2025

(30) Foreign Application Priority Data
Feb. 21, 2024 (JP) 2024-024688

(51) Int. Cl. G09B 5/02; G06F 3/12; G09B 7/06

(52) U.S. Cl. CPC G09B 5/02; G06F 3/1205; G06F 3/1253; G09B 7/06

(57) ABSTRACT

In an information processing system including an external server and a host terminal capable of communicating various kinds of information with the external server. The external server has a transmission unit that transmits a learning content to the host terminal. The host terminal has a reception unit that receives the learning content from the external server and a determination unit that determines a learning medium on which to show the learning content.

### BACKGROUND OF THE INVENTION

### Field of the Invention

The present disclosure relates to an information processing system, an information processing method, and a computer-readable storage medium.

### Description of the Related Art

As the prior art, Japanese Patent Laid-Open No. 2014-035455 discloses a technique of presenting a teacher with learning contents evaluated based on reactions and the like of students during a class so that the teacher can select a learning content from which a learning effect suitable for teacher's lesson plans can be expected.

However, in a case where the objective of a learning content is to, for example, store in memory, a paper medium is preferable from the perspective of better stimulation of brain activities. Meanwhile, in a case where the objective of a learning content is to, for example, provide information, there is no need to use the paper medium, and a digital medium may be used. The techniques in the prior art, however, lack such an idea of presenting a learning medium according to an objective.

### SUMMARY OF THE INVENTION

An information processing system according to an aspect of the present disclosure is an information processing system including an external server and a host terminal capable of communicating various kinds of information with the external server. The external server has a transmission unit that transmits a learning content to the host terminal. The host terminal has a reception unit that receives the learning content from the external server and a recommendation unit that recommends at least one of a paper medium and a digital medium as a learning medium on which to show the learning content.

Further features of the present invention will become apparent from the following description of exemplary embodiments with reference to the attached drawings.

### BRIEF DESCRIPTION OF THE DRAWINGS

FIG. 1 is a diagram of a network configuration of an information processing system;

FIG. 2 is a diagram showing an example of a schematic configuration of an image formation apparatus in FIG. 1;

FIG. 3 is a diagram showing an example of an internal configuration of the image formation apparatus in FIG. 1;

FIG. 4 is a block diagram showing a hardware configuration of the image formation apparatus in FIG. 1;

FIG. 5 is a block diagram showing a hardware configuration of a management server in FIG. 1;

FIG. 6 is a block diagram showing a hardware configuration of a host terminal in FIG. 1;

FIG. 7 is a sequence diagram showing a process of signing up for a learning service;

FIG. 8 is a flowchart illustrating learning medium selection processing;

FIG. 9 is a flowchart illustrating recommended learning medium determination processing;

FIG. 10 is a diagram showing an example of a subject selection screen;

FIG. 11 is a diagram showing an example of a teaching material selection screen;

FIG. 12 is a diagram showing an example of a downloaded teaching material list display screen;

FIG. 13 is a diagram showing an example of a screen where a digital medium is displayed as a learning medium;

FIG. 14 is a diagram showing an example of a print confirmation screen for a print instruction for a paper medium as a learning medium;

FIG. 15 is a diagram showing an example of a recommended learning medium for each of learning fields;

FIG. 16 is a diagram showing an example of a learning medium selection screen;

FIG. 17 is a flowchart illustrating answer transmission processing;

FIG. 18 is a flowchart illustrating average score calculation processing;

FIG. 19 is a flowchart illustrating learning medium selection processing;

FIG. 20 is a diagram showing an example of a learning medium selection screen;

FIG. 21 is a flowchart illustrating recommended print setting processing for paper media; and

FIG. 22 is a diagram showing an example of recommended print settings for paper media for the respective learning fields.

### DESCRIPTION OF THE EMBODIMENTS

Preferred embodiments of the present disclosure are described in detail below with reference to the drawings attached hereto. Note that the embodiments below are not intended to limit the matters of the present disclosure and that combinations of features described in the embodiments below are not necessarily essential as solutions provided by the present disclosure. Note that the same elements are denoted by the same reference sign.

### First Embodiment

### Overview

The present embodiment describes an example of recommending at least one of a paper medium and a digital medium as a learning medium on which to show a learning content, thereby presenting the learning medium suitable for a learning objective. There are various forms of learning contents, such as an explanatory form and a quiz form, depending on purposes, which are not limited to particular ones. A form of a learning content may additionally have at least one of an audio content and a video content. A learning medium is, for example, at least one of a paper medium and a digital medium. Examples of the paper medium include plain paper and banner paper. The digital medium is a medium capable of communications through at least one of a wired communications medium or a wireless communications medium and can be viewed using various terminals. Also, the digital medium can be saved as needed in various kinds of memories such as semiconductor memory. The learning medium is used by learners such as children and students, but the users are not limited to them. The learning medium may be used by teachers in a position to teach learners in preparing a teaching material for the learners. People targeted to use the learning medium, such as learners and teachers, are referred to as users as needed.

### System Configuration

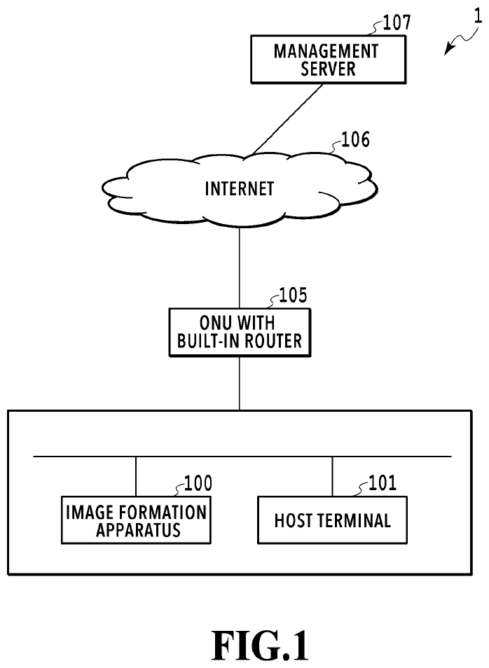

FIG. 1 is a diagram of a network configuration of an information processing system 1. The information processing system 1 includes an image formation apparatus 100, a host terminal 101, an optical network unit (ONU) with built-in router 105, and a management server 107. The image formation apparatus 100 has the function of performing a print operation using consumables. The image formation apparatus 100 may use any of the following printing methods: an electrophotographic method, an inkjet method, a screen printing method, and other methods. The image formation apparatus 100 is communicatively connected to the host terminal 101. The image formation apparatus 100 is connected to the Internet 106 via the ONU with built-in router 105. The host terminal 101 is communicatively connected to the image formation apparatus 100. The host terminal 101 is connected to the Internet 106 via the ONU with built-in router 105. Examples of the host terminal 101 include, but are not particularly limited to, a smartphone, a tablet terminal, and a personal computer. The host terminal 101 may also be, for example, a terminal wearable on the arm such as a smartwatch or, for example, a head-mounted display wearable on the head. The ONU with built-in router 105 is a device where an ONU is equipped with a router function. The ONU is a fiber optic terminating device. The ONU with built-in router 105 is connected to the Internet 106 via fiber optic connection. The ONU with built-in router 105 has the function of converting an optical signal of fiber optic connection to an electric digital signal and vice versa. Thus, the ONU with built-in router 105 can relay information via the Internet 106 between the management server 107 and the image formation apparatus 100 and between the management server 107 and the host terminal 101.

The management server 107 is connected to the Internet 106. Various services provided by the management server 107 are provided via the Internet 106. In the present embodiment, as an external server located outside of the host terminal 101, the management server 107 provides a learning service as one of such services. The learning service is, for example, a service that provides learning contents. Details of learning contents will be described later. Also, the services provided by the management server 107, such as the learning service, may be implemented as cloud services or web services. The management server 107 allows the host terminal 101 to perform a procedure for signing up for the learning service. Upon conclusion of the procedure for signing up for the learning service, the management server 107 holds information on the user who has signed up, identification information on the image formation apparatus 100 to be used for the learning service, answer data or log information transmitted from the image formation apparatus 100. The identification information on the image formation apparatus 100 may be, but not limited to, the serial number of the image formation apparatus 100. The identification information on the image formation apparatus 100 may also be the MAC address of the image formation apparatus 100. In other words, the identification information on the image formation apparatus 100 may be in any form as long as the image formation apparatus 100 can be identified with that information in one and the same network to which the learning service is provided.

The network is a physical network for providing services like the learning service. For example, the network is formed by the management server 107 and the image formation apparatus 100 as a physical network. In this case, the host terminal 101 accesses the management server 107 in performing the procedure for the learning service or using the learning service. For printing on a paper medium, the host terminal 101 accesses the management server 107, and the management server 107 controls the image formation apparatus to that end.

Note that the network may be a virtual network configured to provide services like the learning service. For example, the network may be one large virtual network where the management server 107 and the image formation apparatus 100 are virtually connected. In this case, the host terminal 101 virtually accesses an instance providing the learning service as an instance in cloud computing. Although there are one management server 107 and one image formation apparatus 100 in the example in FIG. 1, the present disclosure is not limited to this. For example, the network may be one large virtual network where a plurality of management servers 107 and a plurality of image formation apparatuses 100 are virtually connected.

The communications medium for connecting the image formation apparatus 100 or the host terminal 101 to the Internet 106 is not limited to a wired communications medium such as fiber optic connection. For example, via a wireless communications medium, the image formation apparatus 100 or the host terminal 101 may be connected to the Internet 106, and be provided with the learning service via the Internet 106. For example, in a case where the host terminal 101 is a mobile terminal such as a smartphone, the mobile terminal may be first connected to a base station via a wireless communications medium and connected to the Internet 106 via the base station, and then be provided with the learning service via the Internet 106.

### Image Formation Apparatus 100

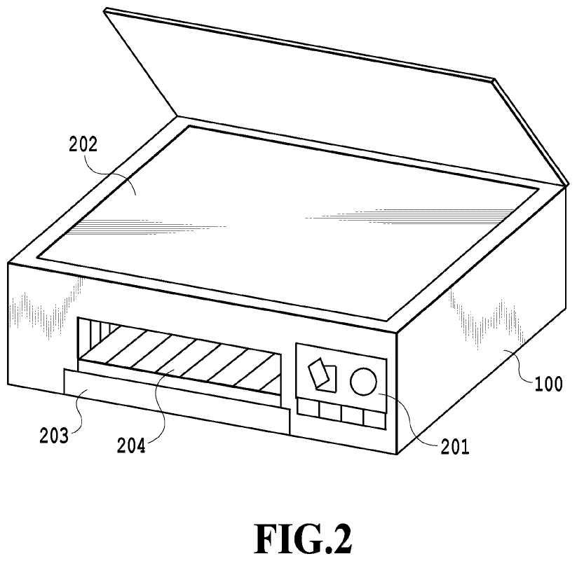

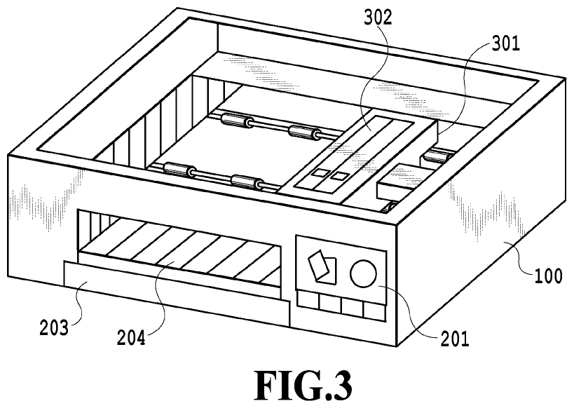

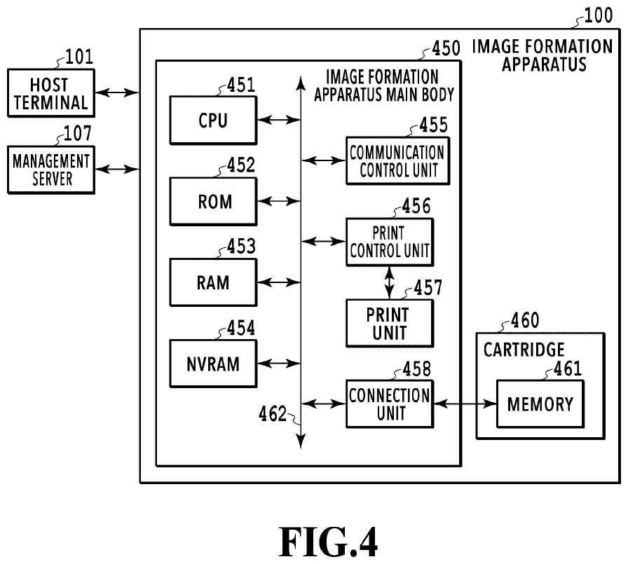

FIG. 2 is a diagram showing an example of a schematic configuration of the image formation apparatus 100 in FIG. 1. The image formation apparatus 100 has a touch panel 201, a platen 202, a paper feed port 203, and a delivery port 204. The touch panel 201 receives various operations for the image formation apparatus 100. Thus, a user is enabled to control the image formation apparatus 100 via the touch panel 201. Note that the touch panel 201 is an example of a user interface for receiving various operations, which is not limited in terms of size, system, and the like and may be a user interface of another type. For example, instead of the touch panel 201, a user interface may be used which receives various operations through push buttons. The platen 202 is formed of a transparent material. A flatbed scanner (not shown) is provided below the platen 202. Thus, the image formation apparatus 100 can scan a sheet in response to placement of the sheet on the platen 202. Data generated by scanning the sheet can be saved in the image formation apparatus 100. Alternatively, data generated by scanning the sheet can be transmitted to the management server 107 from the image formation apparatus 100. A sheet herein refers to a paper medium having at least one of text and an image printed on at least one of its front and back surfaces. Although the present embodiment describes an example where the scan mechanism is formed of a flatbed scanner, the present disclosure is not limited to this particular example. The scanner mechanism may be formed of a sheet-feed scanner or an overhead scanner. FIG. 3 is a diagram showing an example of an internal configuration of the image formation apparatus 100 in FIG. 1. The image formation apparatus 100 has a carriage 301. The carriage 301 houses an ink tank 302. The ink tank 302 is filled with a printing material. FIG. 4 is a block diagram showing a hardware configuration of the image formation apparatus 100 in FIG. 1. The image formation apparatus 100 has an image formation apparatus main body 450 and a cartridge 460. The image formation apparatus main body 450 has the function of performing a print operation using the printing material. As will be described later, the cartridge 460 is filled with the printing material. The image formation apparatus main body 450 has a central processing unit (CPU) 451, a read-only memory (ROM) 452, and a random-access memory (RAM) 453. Also, the image formation apparatus main body 450 has a non-volatile RAM (NVRAM) 454, a communication control unit 455, a print control unit 456, a print unit 457, and a connection unit 458.

The CPU 451 functions as a system control unit of the image formation apparatus 100. The CPU 451 performs overall control of the image formation apparatus 100. The CPU 451 is also referred to as an element 451 as needed. The ROM 452 holds control execution code (program) for the image formation apparatus 100. The ROM 452 is also referred to as an element 452 as needed. The RAM 453 temporarily stores image data to be printed during control execution of the image formation apparatus 100. The RAM 453 is also referred to as an element 453 as needed. The NVRAM 454 is formed of a non-volatile memory. The NVRAM 454 stores contract information necessary for maintenance of the image formation apparatus 100 and print information which is image-related information for recording or printing various kinds of data. The NVRAM 454 is also referred to as an element 454 as needed. The communication control unit 455 controls delivery of data to and from the outside via the Internet 106 or various interfaces. The communication control unit 455 is also referred to as an element 455 as needed. The print control unit 456 controls print processing through the print unit 457. The print control unit 456 is also referred to as an element 456 as needed. The print unit 457 is provided as the carriage 301 in FIG. 3 and performs print processing upon receipt of a print command from the print control unit 456. The print unit 457 is also referred to as an element 457 as needed.

Note that print information is a learning content received from the management server 107. The print information is generated by the print control unit 456 in the unit of a job involving a print operation. Alternatively, the print information is generated by scanning of a learning content placed on the platen 202, the learning content having answers completed by a student. The generated print information is transmitted to the management server 107 by the communication control unit 455. The cartridge 460 is filled with the printing material. The printing material is ink used by the print unit 457 in printing at least one of text and an image on a paper medium. The cartridge 460 is configured to be removable from the connection unit 458 for replacement. The connection unit 458 is also referred to as an element 458 as needed. The cartridge 460 is, for example, an ink cartridge like the ink tank 302 shown in FIG. 3. The ink cartridge is filled with a printing material for use in the inkjet printing method. Alternatively, the cartridge 460 may be, for example, a toner cartridge. A toner cartridge is filled with a printing material for use in the electrophotographic method. The cartridge 460 has a memory 461. The memory 461 records first cartridge information for identifying the cartridge 460 and second cartridge information for indicating ink remaining level information. The first cartridge information is a serial number allocated to the cartridge 460 at the time of manufacture. The second cartridge information is information related to the level of ink remaining in the cartridge 460 and may be represented using a unit of volume. Alternatively, the second cartridge information may be represented as one of ink remaining levels divided using predetermined thresholds.

The elements 451 to 458 described above can be connected to one another via a bus 462. The bus 462 is managed by the CPU 451.

### Management Server 107

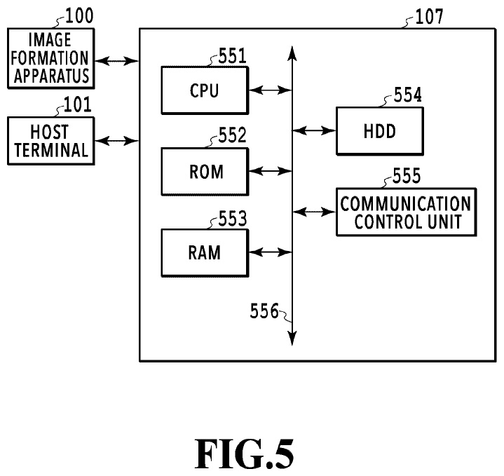

FIG. 5 is a block diagram showing a hardware configuration of the management server 107 in FIG. 1. The management server 107 has a CPU 551, a ROM 552, a RAM 553, a hard disc drive (HDD) 554, and a communication control unit 555.

The CPU 551 functions as a system control unit of the management server 107. The CPU 551 performs overall control of the management server 107. The CPU 551 is also referred to as an element 551 as needed. The ROM 552 holds control execution code (program) for the management server 107. The ROM 552 may hold, e.g., an operating system (OS) or an embedded operating system (EOS). The ROM 552 is also referred to as an element 552. The RAM 553 temporarily stores various kinds of data during control execution of the management server 107. The RAM 553 is also referred to as an element 553 as needed. The HDD 554 is formed of a non-volatile memory. The HDD 554 stores various kind of data necessary for maintenance of the management server 107. The HDD 554 stores user information on a user who has signed up for the learning service. The HDD 554 stores identification information on the image formation apparatus 100 to be used for the learning service. As described earlier, the identification information on the image formation apparatus 100 is, for example, the serial number of the image formation apparatus 100. The HDD 554 holds answer data or log information transmitted from the image formation apparatus 100. The HDD 554 is also referred to as an element 554 as needed. The communication control unit 555 controls delivery of data to and from the outside via the Internet 106 or various interfaces. The communication control unit 555 is also referred to as an element 555 as needed.

The elements 551 to 555 described above can be connected to one another via a bus 556. The bus 556 is managed by the CPU 551.

### Host Terminal 101

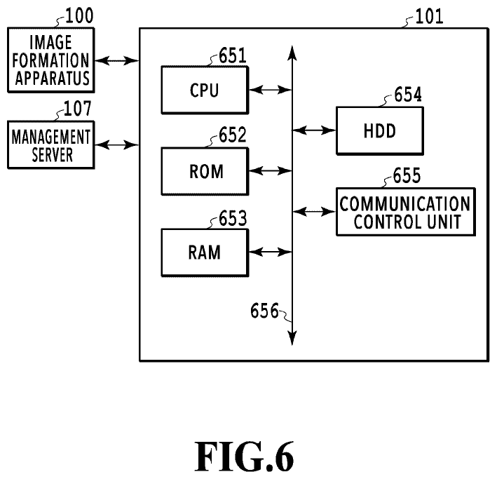

FIG. 6 is a block diagram showing a hardware configuration of the host terminal 101 in FIG. 1. The host terminal 101 has a CPU 651, a ROM 652, a RAM 653, an HDD 654, and a communication control unit 655. The host terminal 101 is a communication device that can communicate with the management server 107 by connecting to the network via the Internet 106 and can communicate with the image formation apparatus 100 as well.

The CPU 651 functions as a system control unit of the host terminal 101. The CPU 651 performs overall control of the host terminal 101. The CPU 651 is also referred to as an element 651 as needed. The CPU 651 activates an application, such as a web browser, which enables use of a web service or web content and is stored in the ROM 652. Next, using the communication control unit 655, the CPU 651 accesses the management server 107 and performs the procedure for signing up for the learning service. The ROM 652 is also referred to as an element 652 as needed. The communication control unit 655 is also referred to as an element 655 as needed. The RAM 653 temporarily stores various kinds of data during control execution of the host terminal 101. The RAM 653 is also referred to as an element 653 as needed. The HDD 654 is formed of a non-volatile memory. The HDD 654 stores various kinds of data necessary for maintenance of the host terminal 101. The HDD 654 is also referred to as an element 654 as needed.

The elements 651 to 655 described above can be connected to one another via a bus 656. The bus 656 is managed by the CPU 651.

### Process of Signing Up for Learning Service

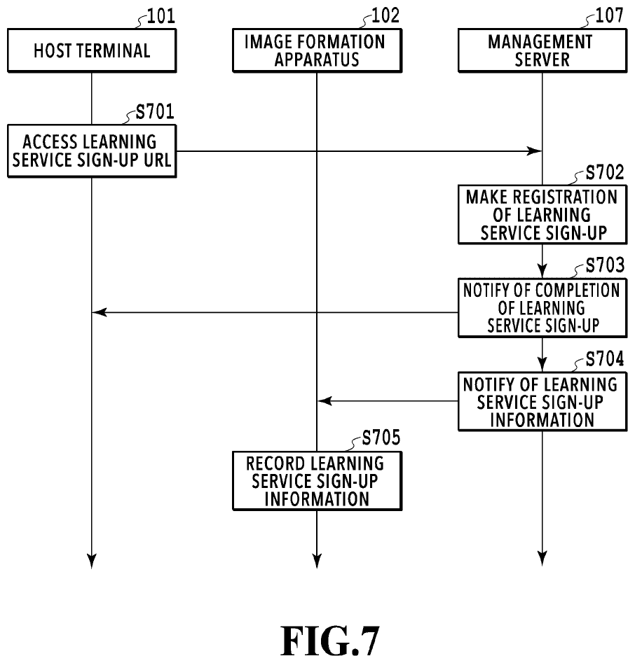

Next, using FIG. 7, a description is given of a process of singing up for a learning service in an example of the present invention. FIG. 7 is a sequence diagram showing the process of signing up for the learning service. The processing shown in FIG. 7 is implemented by the CPU 651 of the host terminal 101, the CPU 551 of the management server 107, and the CPU 451 of the image formation apparatus 100 cooperating with one another. Note that all or some of the functions in the steps in FIG. 7 may be implemented by hardware such as an ASIC or an electronic circuit. The letter “S” in the description of the processing below means a step in the flowchart.

The processing shown in FIG. 7 starts in the event where the host terminal 101 attempts to access a uniform resource locator (URL) for signing up for the learning service of the management server 107. In S701, via a web browser or another application, the host terminal 101 accesses the learning service sign-up URL of the management server 107. Specifically, the web browser executed by the CPU 651 of the host terminal 101 (hereinafter referred to as the web browser in the host terminal 101 as needed) performs the following operation. Specifically, the web browser in the host terminal 101 refers to the learning service sign-up URL of the management server 107 and requests a web server identified with the learning service sign-up URL to transmit data on a learning service sign-up web page. The web browser in the host terminal 101 obtains resources transmitted from the management server 107 in response to this request, performs rendering, and displays the learning service sign-up web page on the web browser. In S702, the web browser in the host terminal 101 receives entry of information necessary for signing up for the learning service from the user. Examples of the information necessary for signing up for the learning service include the name or the mailing address of the subscriber, and a payment method. After confirming that the information necessary for signing up for the learning service is entered correctly via the web browser in the host terminal 101, in S703 the CPU 551 of the management server 107 issues a learning service sign-up completion notification to the host terminal 101. After that, upon conclusion of a sign-up for the learning service, in S704, the CPU 551 of the management server 107 transmits learning service sign-up information to the image formation apparatus 100. In S705, the CPU 451 of the image formation apparatus 100 records the learning service sign-up information. The recording may be done on a paper medium or a digital medium. In a case of recording on a paper medium, the image formation apparatus 100 prints the learning service sign-up information on the paper medium. In a case of recording on a digital medium, the image formation apparatus 100 saves the learning service sign-up information in a data format viewable on the digital medium. With this, various services related to the learning service start to be provided to the user.

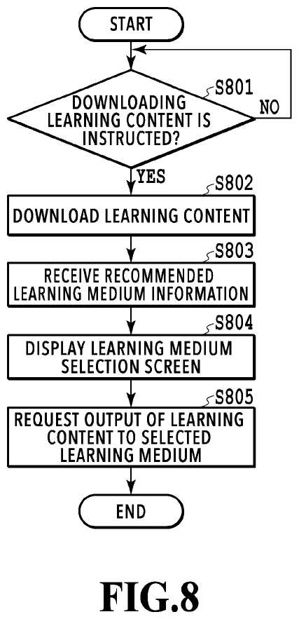

Next, using FIG. 8, a description is given of a process of selecting a learning medium to use for a learning content downloaded to the host terminal 101. FIG. 8 is a flowchart illustrating learning medium selection processing. The processing shown in FIG. 8 is implemented by the CPU 651 of the host terminal 101 and the CPU 551 of the management server 107 cooperating with each other. Note that all or some of the functions in the steps in FIG. 8 may be implemented by hardware such as an ASIC or an electronic circuit. The letter “S” in the description of the processing below means a step in the flowchart.

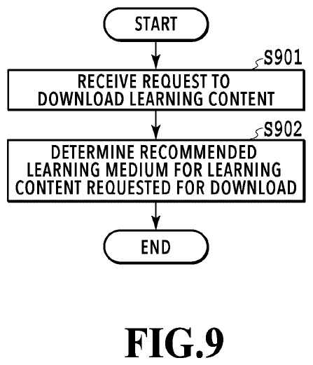

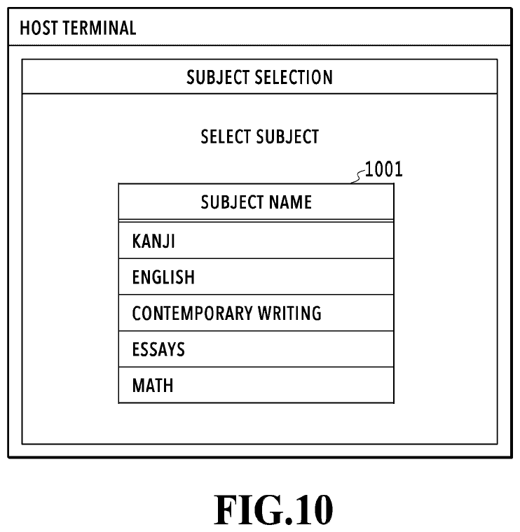

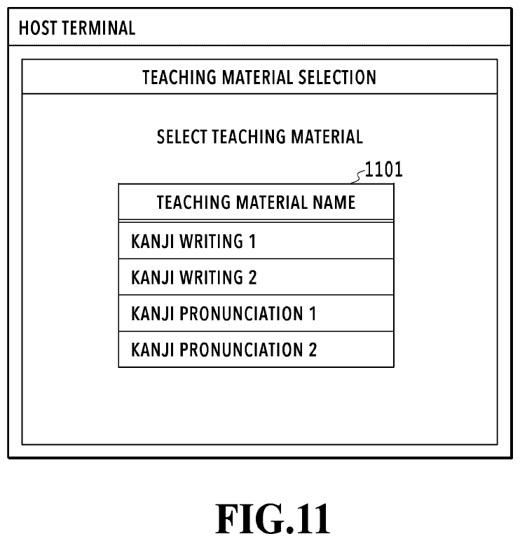

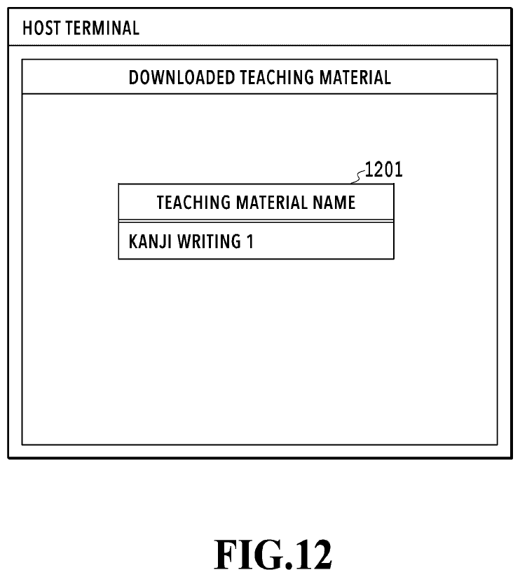

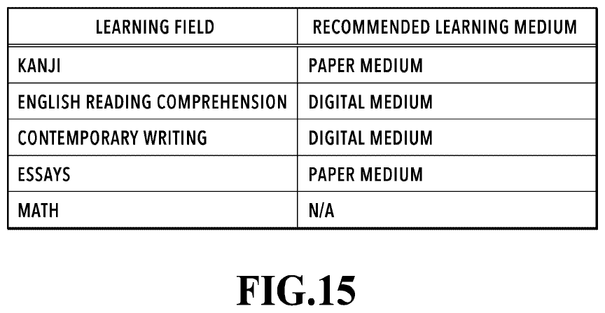

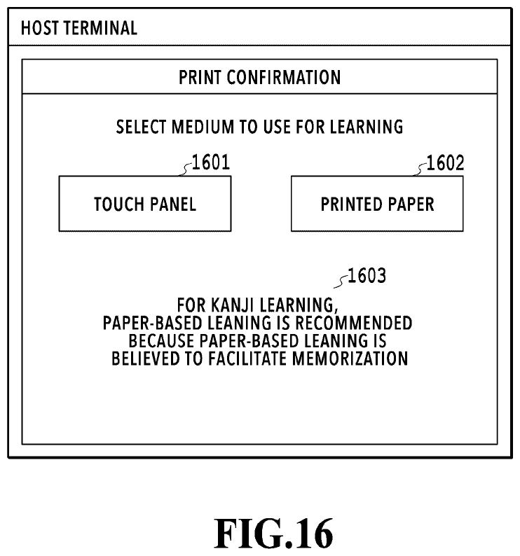

The processing shown in FIG. 8 starts once the host terminal 101 executes processing to prompt selection of a learning content. Although a series of steps performed by the host terminal 101 are shown in the description using FIG. 8, the image formation apparatus 100, instead, may operate as a main actor that downloads a learning content and performs control. In S801, the CPU 651 of the host terminal 101 (hereinafter shortened as the CPU 651 as needed) determines whether a learning content download instruction (also referred to as download request) is issued. FIG. 10 shows an example of the learning content download instruction. FIG. 10 is a diagram showing an example of a subject selection screen. FIG. 10 shows the example where the CPU 651 displays a subject selection screen including a subject options image 1001 and a message for a user. As the message for the user, “SELECT SUBJECT” is displayed. The subject options image 1001 includes a title and specific items for the title. As the title, “SUBJECT NAME” is displayed. As the specific items for the title, “KANJI,” “ENGLISH,” “CONTEMPORARY WRITING,” “ESSAYS,” and “MATH” are displayed, arranged vertically. For example, in a case where the user selects KANJI through the host terminal 101, the subject selection screen transitions to a teaching material selection screen. An example of the teaching material selection screen is described using FIG. 11. FIG. 11 is a diagram showing an example of the teaching material selection screen. FIG. 11 shows an example where the CPU 651 displays a teaching material selection screen including a teaching material options image 1101 and a message for the user. As the message for the user, “SELECT TEACHING MATERIAL” is displayed. The teaching material options image 1101 includes a title and specific items for the title. As the title, “TEACHING MATERIAL NAME” is displayed. As the specific items for the title, “KANJI WRITING 1,” “KANJI WRITING 2,” “KANJI PRONUNCIATION 1,” and “KANJI PRONUNCIATION 2” are displayed, arranged vertically. In a case where the user selects “KANJI WRITING 1,” the CPU 651 determines that a learning content download instruction is issued and proceeds from the processing in S801 to processing in S802. In S802, the CPU 651 downloads the learning content from the management server 107 and saves the learning content to the HDD 654. Once the learning content is saved to the HDD 654, the content of the downloaded teaching material is displayed for the user. FIG. 12 is a diagram showing an example of a downloaded teaching material list display screen. FIG. 12 shows an example where the CPU 651 displays a downloaded teaching material list display screen including a learning content list display image 1201. The learning content list display image 1201 includes a title and a specific item for the title. As the title, “TEACHING MATERIAL NAME” is displayed. As the specific item for the title, “KANJI WRITING 1” is displayed. In other words, a list of downloaded learning contents is displayed on the learning content list display image 1201. The CPU 651 proceeds from the processing in S802 to processing in S803. In S803, regarding a medium to use to learn the learning content downloaded in the processing in S802, the CPU 651 obtains recommended learning medium information indicative of a recommended learning medium from the management server 107 and saves the recommended learning medium information to the HDD 654. The recommended learning medium information will be described later using FIGS. 9 and 15. The CPU 651 proceeds from the processing in S803 to processing in S804. In S804, the CPU 651 displays a learning medium selection screen using a web browser or a dedicated application. FIG. 16 is a diagram showing an example of the learning medium selection screen. FIG. 16 shows an example where the CPU 651 displays a learning medium selection screen including a digital medium selection icon 1601, a paper medium selection icon 1602, and a recommendation comment field 1603. The digital medium selection icon 1601 is formed of a rectangular icon disposed on the left side of a center part of the learning medium selection screen and has text “TOUCH PANEL” displayed thereon. The paper medium selection icon 1602 is formed of a rectangular icon disposed on the right side of the center part of the learning medium selection screen and has text “PRINT ON PAPER” displayed thereon. The recommendation comment field 1603 is disposed at a center side of a lower part of the learning medium selection screen, and displays, for example, the following text as the recommended learning medium information received in S803: “FOR KANJI LEARNING, PAPER-BASED LEANING IS RECOMMENDED BECAUSE PAPER-BASED LEANING IS BELIEVED TO FACILITATE MEMORIZATION.” On the learning medium selection screen, an option to learn on a printed paper medium is displayed as the paper medium selection icon 1602 and an option to learn on the host terminal 101 is displayed as the digital medium selection icon 1601. On the learning medium selection screen, the recommended learning medium information is also displays in the recommendation comment field 1603. In the event where the digital medium selection icon 1601 or the paper medium selection icon 1602 is selected, the CPU 651 proceeds from the processing in S804 to processing in S805. In S805, based on an operation performed on the learning medium selection screen, the CPU 651 requests output of the learning content to the learning medium selected by the user.

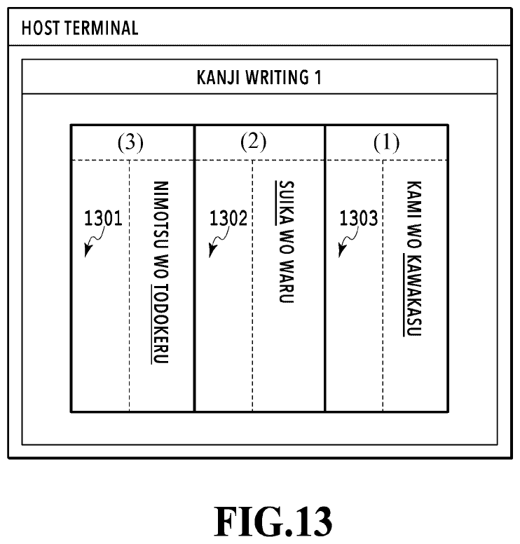

For example, in a case where the user selects the digital medium selection icon 1601, the CPU 651 displays the learning content on the web browser or the dedicated application in the host terminal 101. FIG. 13 is a diagram showing an example of a screen displayed on the digital medium selected as the learning medium. In FIG. 13, after “KANJI WRITING 1” is selected as a learning content, a blank 1301 and a question for the blank 1301 are displayed side by side. Specifically, a question, “nimotsu wo todokeru” (deliver a package), is displayed with “todokeru” (deliver) underlined. The blank 1301 for this question is ready to receive an entry from the user. The user can thus use the learning content by answering this question. Similarly to the blank 1301, blanks 1302 and 1303 have corresponding questions beside them. Specifically, a question, “suika wo waru” (split a watermelon) is displayed with “suika” (watermelon) underlined. The blank 1302 for this question is ready to receive an entry from the user. Similarly to the blank 1301, the user can thus use the learning content. Also, a question, “kami wo kawakasu” (dry hair) is displayed with “kawakasu” (dry) underlined. The blank 1303 for this question is ready to receive an entry from the user. Similarly to the blank 1301, the user can thus use the learning content.

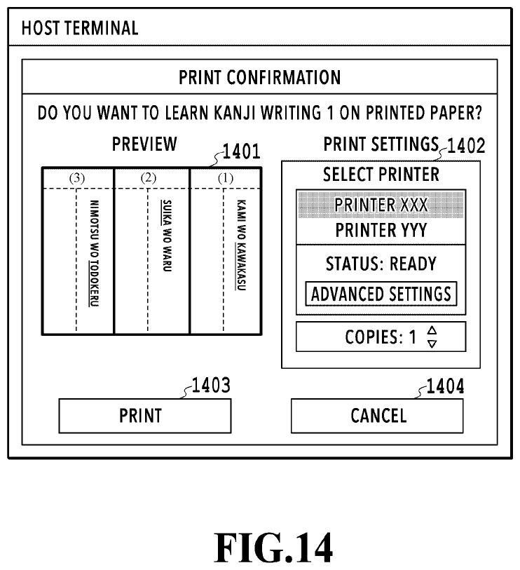

On the other hand, in a case where the user selects the paper medium selection icon 1602, the CPU 651 issues a print instruction to the image formation apparatus 100. FIG. 14 is a diagram showing an example of a print confirmation screen for an instruction to print on a paper medium as the learning medium. FIG. 14 shows an example where the CPU 651 displays a print confirmation screen including a preview field 1401, a print settings field 1402, a print icon 1403, and a cancel icon 1404. The preview field 1401 is disposed on the left side of a center part of the print confirmation screen. The preview field 1401 displays an image to be printed for the learning content. The print settings field 1402 is disposed at the right side of the center part of the print confirmation screen. In the print settings field 1402, two printers available for printing on paper media are listed, arranged vertically. Although the print settings field 1402 displays a list of Printer XXX and Printer YYY, the print settings field 1402 is not limited to this. In the print settings field 1402, Printer XXX selected by the user is displayed hatched, its current status is displayed as “ready to print,” and advanced settings are also displayed in a configurable manner. In the print settings field 1402, a copy count setting reception icon is also displayed as a print setting. The print icon 1403 is formed of a rectangular icon disposed on the left side of a lower part of the print confirmation screen and has text “PRINT” displayed thereon. The cancel icon 1404 is formed of a rectangular icon disposed on the right side of the lower part of the print confirmation screen and has text “CANCEL” displayed thereon. For example, in a case where the user selects the print icon 1403, the CPU 651 issues a print instruction to the image formation apparatus 100, and the image formation apparatus 100 performs a print operation based on the print instruction. For example, a dedicated printer driver is used for the print operation by the image formation apparatus 100. Meanwhile, in a case where the user selects the cancel icon 1404, the CPU 651 causes the screen to transition from the print confirmation screen in FIG. 14 to the learning medium selection screen in FIG. 16.

Next, the recommended learning medium information is described using FIG. 9. FIG. 9 is a flowchart illustrating recommended learning medium determination processing. The processing shown in FIG. 9 is implemented by the CPU 651 of the host terminal 101 and the CPU 551 of the management server 107 cooperating with each other. Note that all or some of the functions in the steps in FIG. 9 may be implemented by hardware such as an ASIC or an electronic circuit. The letter “S” in the description of the processing below means a step in the flowchart.

The processing shown in FIG. 9 starts in response to the processing in S801 in FIG. 8. In S901, the CPU 551 of the management server 107 (hereinafter shortened as the CPU 551 as needed) receives the learning content download request in S801. In S902, the CPU 551 determines a recommended learning medium for the learning content requested for download. The CPU 551 generates learning medium information indicative of the recommended learning medium determined. The learning medium information thus generated is obtained by the processing in S803. Recommended learning media are classified by, for example, learning fields. FIG. 15 is a diagram showing an example of a recommended learning medium for each learning field. In the example in FIG. 15, a manager of the management server 107 predetermines a recommended learning medium for each learning field. The learning fields in FIG. 15 include learning fields requiring memorization. Examples of the learning fields requiring memorization include KANJI and ESSAYS. The paper medium may be recommended as a learning medium for KANJI and ESSAYS. A sheet as a paper medium having a learning content printed thereon is expected to, for example, stimulate the five senses of a learner using that sheet as needed because on not only visual perception but also touch of the learner is actively stimulated for learning. The learning fields in FIG. 15 also include learning fields which involve less writing. Examples of the learning fields which involve less writing include ENGLISH READING COMPREHENSION and CONTEMPORARY WRITING. The digital medium may be recommended as a learning medium for ENGLISH READING COMPREHENSION and CONTEMPORARY WRITING. In this way, the management server 107 generates the recommended learning medium information based on the learning field of the learning content. The recommended learning medium information indicates that any one of the paper medium and the digital medium is recommended. The learning fields in FIG. 15 include a learning field for which it is difficult to determine a recommended learning medium. An examples of the learning field for which it is difficult to determine a recommended learning medium is MATH. MATH is a learning field that benefits from use of a paper medium because the paper medium activates the brain, but does not require memorization as much as KANJI. MATH is presumably a learning field which prioritizes a thinking process rather than memorization; thus, in the example in FIG. 15, the recommended learning medium is defined as “N/A” as it is a field for which it is difficult to determine a recommended learning medium. For a learning field for which the benefit by use of the paper medium is even small, the paper medium may be defined as the recommended learning medium, like essays. In other words, based on the level of memorization required by a learning content, the management server 107 generates the recommended learning medium information indicating that any one of the paper medium and the digital medium is recommended. Although learning contents are classified according to the learning fields in FIG. 15, the learning contents may be classified according to, for example, question formats: a multiple-choice format and a description format. For example, the digital medium may be recommended for the multiple-choice question, which involves less writing. On the other hand, the paper medium may be recommended for the question in the description format.

### Modification of First Embodiment

Although any one of the paper medium and the digital medium is recommended as the recommended learning medium in the example described above, use of both of the paper medium and the digital medium may be recommended. For example, for learning, it is possible to display question sentences on a digital medium and output writing sections to a paper medium. With such an operation, while the costs of printing the question sentences are cut down, a learner can have their brain activated by using the paper medium for the writing sections and memorize the material.

In the present embodiment described above, the host terminal 101 recommends at least one of the paper medium and the digital medium as the learning medium on which to show a learning content. With such an operation, a learner who uses the learning content for learning can learn by using the recommended learning medium. Thus, in a case where a recommended learning medium is suitable for a learning objective, the learning medium suitable for the learning objective can be presented.

Also, in the present embodiment, the host terminal 101 may receive selection of any one of the paper medium and the digital medium. Such an operation makes it possible to provide the learning medium selected by the host terminal 101.

Also, in the present embodiment, the management server 107 may generate the recommended learning medium information indicating that the paper medium or the digital medium is recommended based on the level of memorization required by the learning content. Such an operation makes it possible to present a learning medium based on the level of memorization; hence, in a case where memorization is more necessary, the learning medium suitable for memorization is presented.

Also, in the present embodiment, the management server 107 may generate the recommended learning medium information indicating that any one of the paper medium and the digital medium is recommended based on the learning field of the learning content. Because learning fields have their suitable learning objectives, such an operation makes it possible to present a more suitable learning medium according to the more detailed learning objective.

Also, in the present embodiment, the management server 107 may generate the recommended learning medium information indicating that any one of the paper medium and the digital medium is recommended based on the learning field of the learning content and the answer format of a task in the learning content. Because the answer format is considered in addition to the learning field, such an operation enables more efficient learning.

Also, in the present embodiment, in a case where the answer format is a multiple-choice format, the management server 107 generates the recommended learning medium information indicating that the digital medium is recommended. With such an operation, the digital medium is recommended for a multiple-choice format. Because a multiple-choice format involves less writing than a description format, the benefit by use of the digital medium to reduce the print costs is higher than the benefit by use of the paper medium.

Also, in the present embodiment, in a case where the answer format is a description format, the management server 107 generates the recommended learning medium information indicating that the paper medium is recommended. Such an operation recommends the paper medium for the description format. For the description format which involves more writing than the multiple-choice format, the benefit by use of the paper medium is higher than the benefit by use of the digital medium because the paper medium enables better memorization.

Also, in the present embodiment, the host terminal 101 may recommend at least one of the paper medium and the digital medium based on the recommended learning medium information generated by the management server 107. With such an operation, the learning medium is recommended using the recommended learning medium information generated based on the level of memorization. Hence, better memorization is enabled.

Also, in the present embodiment, the host terminal 101 may further have a learning unit that enables learning on digital media. Such a configuration allows a learner to learn using the host terminal 101.

Also, in the present embodiment, an image formation apparatus that prints on paper media may be further provided. Such a configuration enables learning using paper media.

### Second Embodiment

Next, a second embodiment is described. In the first embodiment, the management server 107 classifies learning contents into several learning fields, and the manager of the management server 107 (hereinafter shortened as a manager as needed) predetermines the recommended learning medium for each of the learning fields. Such a configuration makes it possible to notify the host terminal 101 of the recommended learning medium. However, the recommended learning medium determined and notified of by the manager may be different from a learning medium that is actually effective for learning. In the second embodiment, it is assumed that a learning content includes a task in a certain answer format. On such assumption, the management server 107 collects, from a plurality of learners of the learning content, answers given to the task and information on the learning media used by the learners. Then, the management server 107 calculates the average score of the answers collected from the plurality of learners for each of the learning media, and causes the average scores for the respective learning media to be displayed on the host terminal 101.

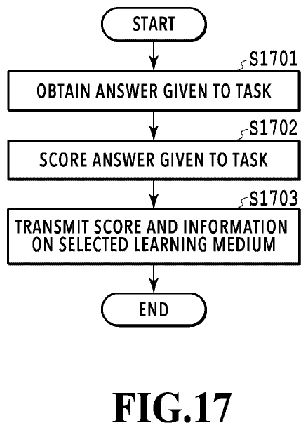

The second embodiment is described mainly in terms of differences from the first embodiment. The second embodiment has the same configuration as the first embodiment in FIGS. 1 to 7, and thus, descriptions thereof are omitted. Using FIG. 17, a description is given of a process where, after a learner of a learning content gives an answer to a task included in the learning content, the host terminal 101 transmits the answer given to the task to the management server 107.

FIG. 17 is a flowchart describing answer transmission processing. The processing shown in FIG. 17 is implemented by the CPU 651 of the host terminal 101 and the CPU 551 of the management server 107 cooperating with each other. Note that all or some of the functions in the steps in FIG. 17 may be implemented by hardware such as an ASIC or an electronic circuit. The letter “S” in the description of the processing below means a step in the flowchart.

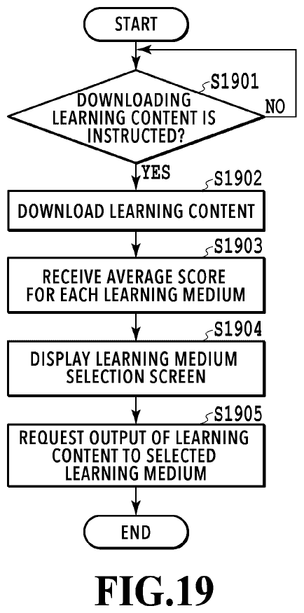

The processing shown in FIG. 17 starts once a learner of a learning content gives an answer to a task included in the learning content. In S1701, the CPU 651 obtains the answer given by the learner of the learning content. For example, as will be described in detail later using FIG. 19, in a case where learning on the host terminal 101, i.e., a digital medium, is selected in S1905 in FIG. 19, it is conceivable that a task is displayed on the host terminal 101, and an answer to the task is received from the host terminal 101. Alternatively, in a case where learning on a printed paper medium is selected in S1905, it is conceivable that the learner writes an answer to the task on the paper, and the paper is then scanned with the image formation apparatus 100. The host terminal 101 can obtain the answer to the task by receiving the scan result from the image formation apparatus 100. The CPU 651 proceeds from the processing in S1701 to processing in S1702. In S1702, the CPU 651 scores the answer to the task obtained in the processing in S1701. Examples of the scoring method include optical character recognition technology. Another scoring method may be an automatic scoring system using machine learning. In another scoring method, a sample answer is prepared for the learning content in advance and compared with the answer visually, and a score is manually inputted. In S1703, the CPU 651 transmits the score and information on the learning medium selected by the user in S804 to the management server 107.

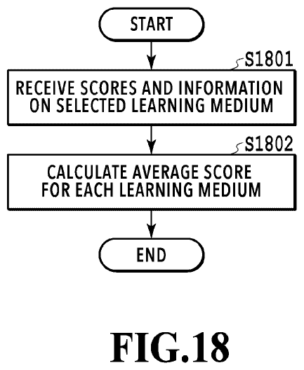

Next, using FIG. 18, a description is given of a process in which the management server 107 receives the score described above and calculates an average score. FIG. 18 is a flowchart illustrating average score calculation processing. The processing shown in FIG. 18 is implemented by the CPU 651 of the host terminal 101 and the CPU 551 of the management server 107 cooperating with each other. Note that all or some of the functions in the steps in FIG. 18 may be implemented by hardware such as an ASIC or an electronic circuit. The letter “S” in the description of the processing below means a step in the flowchart.

The processing shown in FIG. 18 starts in the event where the host terminal 101 transmits the aforementioned score to the management server 107 in S1703. In S1801, the CPU 551 receives the score and the learning medium information transmitted in the processing in S1703 and saves them to the HDD 554. In S1802, using a plurality of sets of the scores and learning medium information saved to the HDD 554, the CPU 551 calculates an average score for each of the learning media.

Next, using FIG. 19, a description is given of a process of selecting a learning medium for a learning content downloaded onto the host terminal 101. FIG. 19 is a flowchart illustrating learning medium selection processing. The processing shown in FIG. 19 is implemented by the CPU 651 of the host terminal 101 and the CPU 551 of the management server 107 cooperating with each other. Note that all or some of the functions in the steps in FIG. 19 may be implemented by hardware such as an ASIC or an electronic circuit. The letter “S” in the description of the processing below means a step in the flowchart.

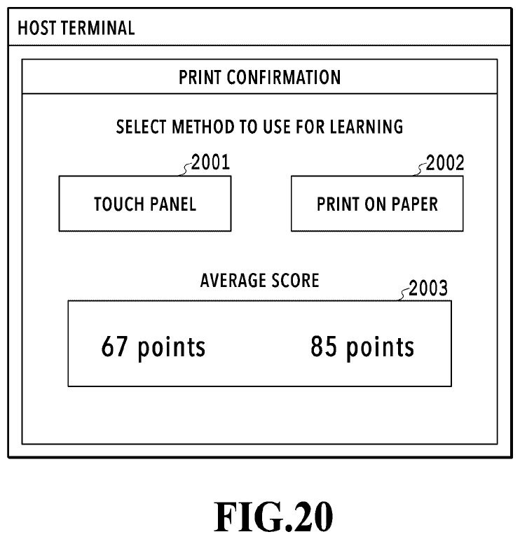

S1901 and S1902 in the processing shown in FIG. 19 are the same as S801 and S802 in FIG. 8 and are therefore not described here. In S1903, the CPU 651 receives the average scores for the respective learning media calculated in S1802 from the management server 107. The CPU 651 proceeds from the processing in S1903 to processing in S1904. In S1904, the CPU 651 displays, on a web browser or a dedicated application, a learning medium selection screen and the average scores for the respective learning media received in S1902. FIG. 20 is a diagram showing an example of the learning medium selection screen. In FIG. 20, a print confirmation screen including a digital medium selection icon 2001, a paper medium selection icon 2002, and an average score display field 203. The digital medium selection icon 2001 and the paper medium selection icon 2002 have the same functions as the digital medium selection icon 1601 and the paper medium selection icon 1602 and are therefore not described here. In the average score display field 203, the CPU 651 displays the average scores for the respective learning media received in S1903. For instance, in the example in FIG. 20, in the average score display field 203, “67” is displayed under the digital medium selection icon 2001 as an average score in the case using the digital medium. Meanwhile, in the average score display field 203, “85” is displayed under the paper medium selection icon 2002 as an average score in the case using the paper medium. In other words, the management server 107 generates the recommended learning medium information based on the answer format (such as the average scores) for a task in the learning content. The CPU 651 proceeds from the processing in S1904 to processing in S1905. The processing in S1905 is the same as the processing in S805 and is therefore not described here.

As described thus far, in the present embodiment, the host terminal 101 displays a first average value of a plurality of answers given to a plurality of tasks included in the learning content using the paper medium and a second average value of a plurality of answers given to the plurality of tasks included in the learning content using the digital medium. Further, while displaying the first average value and the second average value, the host terminal 101 prompts selection of at least one of the paper medium and the digital medium. Such an operation allows the user to select at least one of the paper medium and the digital medium based on the answers given to the tasks. Thus, the learning medium that may offer better results can be selected.

Also, in the present embodiment, an image formation apparatus that scans answers written on paper media may be further provided. Such a configuration can digitize the answers written on paper media and enables the host terminal 101 to compute the first average value.

### Modification of the Second Embodiment

Although the average scores for tasks are shown on the learning medium selection screen in the example described in the present embodiment, the present disclosure is not limited to this. A percentage of correct answers to a task may be shown on the learning medium selection screen. A percentage of correct answers to each task is a ratio of learners who gave correct answers to the task to all learners who gave answers to the task. This also makes it possible to change a learning medium on a task-by-task basis. Alternatively, an average percentage of correct answers to tasks may be calculated using the percentages of the correct answers to the respective tasks and shown on the learning medium selection screen. Alternatively, even in the same learning field, different weights may be assigned to tasks requiring memorization and tasks not requiring memorization to calculate the weighted average value. For example, a case is assumed here where a larger weight is assigned to the tasks requiring memorization than that assigned to the tasks not requiring memorization. In this case, even though the number of tasks requiring memorization is smaller than the number of tasks not requiring memorization, the results for the tasks requiring memorization are emphasized, which enables provision of proper learning medium determination information.

### Third Embodiment

Next, a third embodiment is described. In the examples described in the first and second embodiments, a user is presented with the information for selecting a learning medium to use for a learning content and is allowed to select a learning medium. However, in a case where a user selects a paper medium, a print setting may be unsuitable for the learning content. For example, a case is considered where there is a user who usually prints with a 4-in-1 setting to cut down the number of sheets of plain paper to use. In a case where this user learns geometric figure questions, it is conceivable that the geometric figures printed with the 4-in-1 setting are difficult to view and this user changes the setting to 1-in-1 and prints the questions again. To address this case, the present embodiment describes an example where, in a case where a user selects to learn on the paper medium, a recommended print setting is presented based on the nature of a learning content.

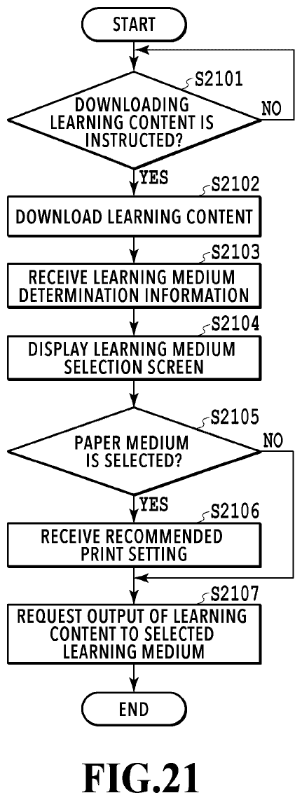

The third embodiment is described mainly in terms of differences from the first and second embodiments. The third embodiment has the same configuration as the first and second embodiments in FIGS. 1 to 7, and thus, descriptions thereof are omitted. In the third embodiment, using FIG. 21, a description is given of a process of proposing a print setting suitable for a learning content downloaded on the host terminal 101 in a case where the paper medium is selected as the learning medium for the learning content.

FIG. 21 is a flowchart illustrating recommended print setting processing for paper media. The processing shown in FIG. 21 is implemented by the CPU 651 of the host terminal 101 and the CPU 551 of the management server 107 cooperating with each other. Note that all or some of the functions in the steps in FIG. 21 may be implemented by hardware such as an ASIC or an electronic circuit. The letter “S” in the description of the processing below means a step in the flowchart.

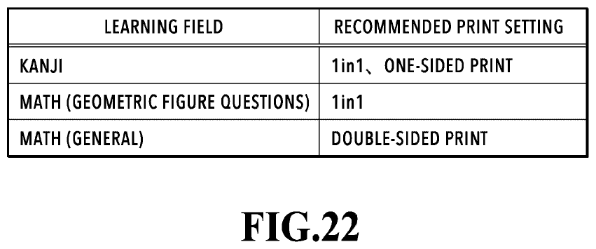

S2101 and S2102 in the processing shown in FIG. 21 are the same as S801 and S802 in FIG. 8 and are therefore not described here. In S2103, the CPU 651 receives learning medium determination information for the user to determine a learning medium, as described in S803 or S1903. In other words, the learning medium determination information is recommended learning medium information or the average scores for tasks. Specifically, the CPU 651 obtains information to be needed in the next processing in S2104. In a case of displaying the learning medium selection screen including the recommendation comment field 1603, the CPU 651 may obtain the recommended learning medium information to be displayed in the recommendation comment field 1603. Alternatively, in a case of displaying a print confirmation screen including the average score display field 203, the CPU 651 may obtain the information on the average score of answers to tasks for each learning medium to be displayed in the average score display field 203. The CPU 651 proceeds from the processing in S2103 to processing in S2104. In S2104, the CPU 651 displays the learning medium selection screen for selecting the learning medium, as described in S804 or S1904. In other words, the management server 107 generates the recommended learning medium information based on the learning field of the learning content and the answer format of tasks in the learning content. The CPU 651 proceeds from the processing in S2104 to processing in S2105. In S2105, the CPU 651 determines whether learning on the paper medium is selected in S2104. If the paper medium is selected in S2104, in S2106, the CPU 651 receives a print setting suitable for the learning content downloaded from the management server 107. In reference to FIG. 22, details of a printing setting suitable for the learning content are described. FIG. 22 is a diagram showing an example of recommended print settings for paper media for the respective learning fields. To be more specific, in FIG. 22, each learning field is associated with a print setting suitable for printing a learning content. From the recommended print settings in FIG. 22, a setting is obtained in the processing in S2106. Specifically, the host terminal 101 obtains the recommended print setting from the management server 107 by receiving it from the management server 107. The management server 107 transmits, to the host terminal 101, the print setting suitable to print the learning content requested from the host terminal 101 based on the recommended print settings in FIG. 22. The recommended print settings in FIG. 22 may be determined as follows: the manager classifies learning contents into several learning fields and determines print settings recommended for the respective learning fields. For example, the 4-in-1 setting provides smaller writing spaces for learners and therefore presumably makes it difficult for the learners to write text. Thus, the 4-in-1 setting is presumably unsuitable for KANJI WRITING. Also, with a double-sided print setting, KANJI strongly written on the front side may be also visible on the back side. For these reasons, a 1-in-1 setting or a one-sided printing setting is recommended for KANJI WRITING. Similarly, geometric figure questions of math printed small presumably are difficult for the learners to view. For this reason, the 1-in-1 setting is recommended for the geometric figure questions of math. Also, for math in general, it is presumed that learners do not apply handwriting pressure so much and that one question does not tend to continue to the next page. For these reasons, the double-sided printing is recommended for math in general. Meanwhile, if learning on the paper medium is not selected in S2104, the CPU 651 skips the processing in S2106 and proceeds to processing in S2107. In S2107, the CPU 651 requests output of the learning content to the learning medium selected in S2103. For example, if learning on the printed paper medium is selected, the CPU 651 issues a print instruction instructing the image formation apparatus 100 to perform printing using the print setting(s) received in S2106, and then ends the series of steps. Alternatively, if learning on the host terminal 101 is selected in S2104, the CPU 651 displays the learning content on the host terminal 101, and then ends the series of steps.

As thus described, in the present embodiment, in a case where the paper medium is selected as the learning medium, the host terminal 101 obtains, from the management server 107, one or some of the recommended print settings made for the respective learning fields of learning contents. Such an operation makes it possible to obtain the print setting(s) suitable for learning in each of the learning fields. This allows a learner to learn on a paper medium printed in a format better suited for the learning objective.

### Other Embodiments

Although at least one of the paper medium and the digital medium is used as the recommended learning medium in the examples described above, the present disclosure is not particularly limited to this. For example, the following mode is possible. During lecture streaming, material for the lecture is displayed on a digital medium, and in a case where writing an answer to a question is requested, the question and an answer field may be outputted to paper media. Also, although the learning medium selection screen is displayed to prompt a user to select the learning medium in S804, S1904, and so on in the above descriptions, the present disclosure is not limited to this. For example, the host apparatus may determine the learning medium automatically (without user's check) based on the received learning medium determination information and output the learning content to the learning medium thus determined.

Also, although the management server 107 generates the recommended learning medium information in the examples described above, the present disclosure is not limited to this. For example, the host terminal 101 may obtain the recommended learning medium information in advance at the time of signing up to use learning contents. Also, the recommended learning medium information may be managed by a server other than the management server 107. Disposing a plurality of servers for respective purposes enables load-distributed operation. However, as in the second embodiment, in the case where the management server 107 collects usage status data such as scores on tasks, the recommended learning medium information is generated based on such collected usage status data. In such a use case, from the perspective of operational management of learning contents, it is preferable that the recommended learning medium information be held on the management server 107 side.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-024688, filed Feb. 21, 2024, which is hereby incorporated by reference wherein in its entirety.

What is claimed is:

1. An information processing system comprising:
an external server and
a host terminal capable of communicating various kinds of information with the external server, wherein
the external server has a transmission unit that transmits a learning content to the host terminal, and
the host terminal has
a reception unit that receives the learning content from the external server and
a determination unit that determines a learning medium on which to show the learning content.

2. The information processing system according to claim 1, wherein
the host terminal further has a recommendation unit that recommends the learning medium determined by the determination unit as the learning medium on which to show the learning content.

3. The information processing system according to claim 2, wherein
the host terminal further has a reception unit that receives selection of whether to use the learning medium recommended by the recommendation unit.

4. The information processing system according to claim 3, wherein
the determination unit determines any one of a paper medium and a digital medium as the learning medium, and
the recommendation unit recommends the paper medium or the digital medium determined by the determination unit.

5. The information processing system according to claim 4, wherein
the external server generates recommended learning medium information based on a level of memorization required by the learning content, the recommended learning medium information indicating that either the paper medium or the digital medium is recommended.

6. The information processing system according to claim 5, wherein
the external server generates the recommended learning medium information based on a learning field of the learning content.

7. The information processing system according to claim 5, wherein
the external server generates the recommended learning medium information based on a learning field of the learning content and an answer format of a task in the learning content.

8. The information processing system according to claim 7, wherein
in a case where the answer format is a multiple-choice format, the external server generates the recommended learning medium information indicating that the digital medium is recommended.

9. The information processing system according to claim 7, wherein
in a case where the answer format is a description format, the external server generates the recommended learning medium information indicating that the paper medium is recommended.

10. The information processing system according to claim 5, wherein
the host terminal recommends at least one of the paper medium and the digital medium based on the recommended learning medium information generated by the external server.

11. The information processing system according to claim 10, wherein
the host terminal further has a learning unit that enables learning on the digital medium.

12. The information processing system according to claim 10, further comprising an image formation apparatus that prints on the paper medium.

13. The information processing system according to claim 4, wherein
the host terminal further has
a display unit that displays a first average value of scores on a plurality of answers given to a plurality of tasks included in the learning content using the paper medium and a second average value of scores on a plurality of answers given to the plurality of tasks included in the learning content using the digital medium, and
a selection unit that prompts selection of at least one of the paper medium and the digital medium with the first average value and the second average value being displayed by the display unit.

14. The information processing system according to claim 13, further comprising an image formation processing that scans the answers written on the paper medium.

15. The information processing system according to claim 11, wherein
in a case where the paper medium is selected as the learning medium, the host terminal obtains a recommended print setting from the external server, the recommended print setting being made for each learning field of the learning content.

16. An information processing method for controlling a host terminal capable of communicating various kinds of information with an external server, the method comprising the steps of:
receiving a learning content from the external server and
recommending at least one of a paper medium and a digital medium as a learning medium on which to show the learning content.

17. A computer-readable storage medium storing a program for causing a computer to
receive a learning content from the external server and
recommend at least one of a paper medium and a digital medium as a learning medium on which to show the learning content.
